(19) United States
(12) Patent Application Publication
(10) Pub. No.: US 2026/0102745 A1
(43) Pub. Date: Apr. 16, 2026

(54) MIXING SYSTEM AND METHOD OF MAKING MIXED COMPOSITIONS

(71) Applicant: The Procter & Gamble Company, Cincinnati, OH (US)

(72) Inventors: Gemma Zoe Braganza, Singapore (SG); Songhai Liang, Singapore (SG); Xiaobing Donald Chen, Singapore (SG)

(21) Appl. No.: 19/350,171

(22) Filed: Oct. 6, 2025

Related U.S. Application Data
(60) Provisional application No. 63/707,891, filed on Oct. 16, 2024.

(51) Int. Cl. B01F 23/50; B01F 25/00; B01F 25/60; B01F 35/00

(52) U.S. Cl. CPC B01F 23/511; B01F 23/56; B01F 23/59; B01F 25/60; B01F 35/55; B01F 2025/93

(57) ABSTRACT

Mixing systems and methods of making mixed compositions including a first composition and a second composition. The systems and methods incorporate a fluid flow manipulation to manage an undesirable accumulation of a separable ingredient such as particles associated with the first and/or second composition as the mixed composition is further processed and packaged downstream.

### FIELD

The present disclosure generally relates to mixing systems and methods of making mixed compositions. The systems and methods herein are particularly useful for making personal care compositions containing particles. They can however be useful for making other types of compositions, such as, for example, cleaning compositions, food and beverage compositions, industrial compositions, and the like.

### BACKGROUND

Personal care compositions containing particles are known. Manufacturing such compositions can however present various challenges. U.S. Pat. No. 11,896,689 (“'689 patent”) discloses methods of making personal care compositions comprising microcapsules, which address some of the manufacturing challenges. In particular, the '689 patent teaches a mixing system that utilizes a lamella pump to mix the microcapsules into a base personal care composition. And, while this patent provides a useful contribution to the arts, microcapsules can undesirably accumulate in a “dead zone” near the pump outlet when processing some personal care compositions by the methods and equipment disclosed in the '689 patent. FIGS. 1 and 2 show an example mixing system as taught by the '689 patent. As can be seen in FIG. 2, an accumulation of particles 210 or composition containing particles 210 can occur within a “dead zone” 212 at the outlet 214 of lamella pump 216. This accumulation can result in poor product performance (not enough particles in the finished product), inefficient use of materials, cost increases, quality issues, and/or present challenges cleaning the equipment between manufacturing runs.

The mixing systems and methods disclosed herein can help mitigate undesirable accumulation of particles and/or composition during the processing of mixed compositions.

### SUMMARY

Improved mixing systems are provided herein. In one form the mixing system comprises a lamella pump including a first inlet for receiving a first composition, a second inlet for receiving a second composition, and an outlet for communicating a mixed composition of the first and second compositions. A downstream pipe is disposed at the pump outlet. An obstruction is disposed on an inner wall of the downstream pipe to partially block and divert flow of the mixed composition.

Improved methods of making mixed compositions are also provided herein. In one form, the method comprises providing a mixer including a first inlet, a second inlet, an outlet, and a downstream pipe extending from the outlet. A first composition is advanced in a flow path from the first inlet and towards the downstream pipe. A second composition is communicated through the second inlet and introduced into the first composition to create a mixed composition. The flow of the mixed composition is partially blocked in a region that is proximate the mixer outlet.

In a second form, the method comprises communicating a plurality of particles through the second inlet and introducing the same into the first composition to create a mixed composition. Flow of the mixed composition is diverted in a region that is proximate the mixer outlet to help manage accumulation of the particles in that region.

In a third form, the method comprises creating an eddy or vortex within the flow of the mixed composition in a region that is proximate the mixer outlet to help manage accumulation of the particles in that region.

### BRIEF DESCRIPTION OF THE DRAWINGS

FIGS. 1 and 2 are an isometric and sectional view, respectively, of a prior art mixing system and compositions being processed therethrough;

FIG. 3 is an isometric view of an exemplary mixing system provided herein;

FIG. 4 is a partial cross-sectional view of the mixing system shown in FIG. 3;

FIGS. 5-8 are isometric views of exemplary obstruction inserts;

FIGS. 9-12 are cross-sectional views of a pipe containing exemplary flow obstructions; and

FIG. 13 is a cross-sectional view of an exemplary mixing system with first and second compositions flowing therethrough.

### DETAILED DESCRIPTION

Mixing systems for combining particles and fluid compositions are known. However, these conventional mixing systems can experience undesirable buildup of material (particles and fluid) at the outlet of the mixer. It has now been discovered that placing a geometrically tailored obstruction at or proximate the outlet of the mixer can reduce or eliminate this undesirable material buildup.

Reference within the specification to “form(s)”, “aspect(s)” or “embodiment(s)” or the like means that a particular material, feature, structure and/or characteristic described in connection with the form/aspect/embodiment is included in at least one form/aspect/embodiment, optionally a number of forms/aspects/embodiments, but it does not mean that all forms/aspects/embodiments incorporate the material, feature, structure, and/or characteristic described. Furthermore, materials, features, structures and/or characteristics may be combined in any suitable manner across different forms/aspects/embodiments, and materials, features, structures and/or characteristics may be omitted or substituted from what is described. Thus, forms/aspects/embodiments described herein may comprise or be combinable with elements or components of other forms/aspects/embodiments despite not being expressly exemplified in combination, unless otherwise stated or an incompatibility is stated.

All ingredient percentages described herein are by weight of the composition, unless specifically stated otherwise, and may be designated as “wt %.” All ratios are weight ratios, unless specifically stated otherwise. All such percentages or weights as they pertain to listed ingredients are based on the active level and, therefore, do not include carriers or by-products that may be included in commercially available materials. The number of significant digits conveys neither a limitation on the indicated amounts nor on the accuracy of the measurements. Unless otherwise indicated, all measurements are understood to be made at approximately 25° C. and at ambient conditions, where “ambient conditions” means conditions under about 1 atmosphere of pressure and at about 50% relative humidity. All ranges are inclusive and combinable. For example, all numeric ranges are inclusive of narrower ranges, and delineated upper and lower range limits are interchangeable to create further ranges not explicitly delineated.

The mixing systems, methods, and compositions of the present invention can comprise, consist essentially of, or consist of, the primary ingredients or components as well as optional materials described herein. As used herein, “consisting essentially of” means that the mixing system, method, or composition may include additional components or ingredients, but only if the additional components or ingredients do not materially alter the basic and novel characteristics of the claimed systems and methods. As used in the description and the appended claims, the singular forms “a,” “an,” and “the” are intended to include the plural forms as well, unless the context clearly indicates otherwise.

“About” modifies a particular value by referring to a range of plus or minus 20% or less of the stated value (for example, plus or minus 15% or less, 10% or less, or even 5% or less).

“Anhydrous particle” herein refers to a particle prepared by co-melting and mixing one or more surfactants and one or more fatty amphiphiles followed by cooling to solidify. The concentration of water in an anhydrous particle is less than 30% (for example, 0% to 25%, 1% to 20%, 2% to 15%, or even 3% to 10%) by weight of the anhydrous particle.

“Base composition” refers to a composition to which anhydrous particles are added. A base composition can be a personal care composition such as a shampoo, conditioner or body wash, or a base composition can be a carrier such as water, with or without other ingredients.

“Particle” refers to a discrete quantity of a composition that has a longest dimension of 20 mm or less (e.g., 50 μm to 15 mm, 100 μm to 10 mm, 500 μm to 5 mm, or even 750 μm to 3 mm). Particles herein can have any suitable shape desired, such as a sphere, sphereoid, hemisphere, prism, cylinder, cone, ribbon, fiber, flake (planar), irregular shape or a combination of these. Some non-limiting examples of particles include microspheres and microcapsules.

“Solid,” when referring to a particle, means that the particle does not conform to the shape of the container in which it is held at 25° C.

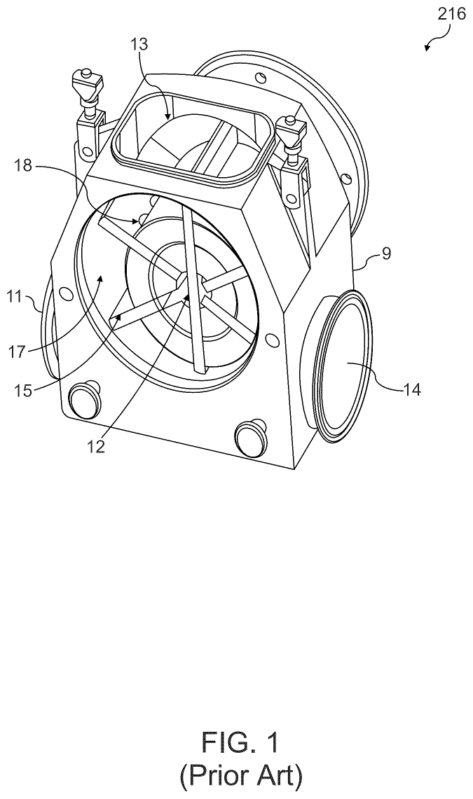

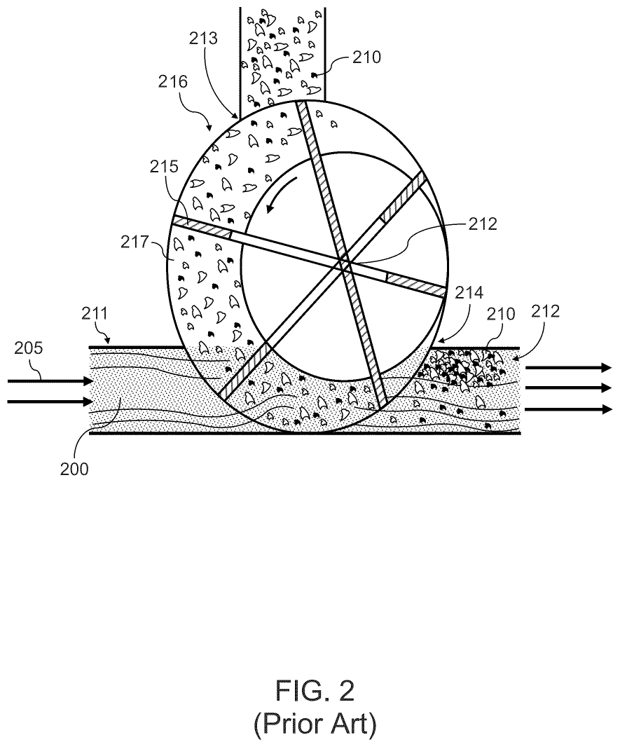

FIGS. 1 and 2 illustrate an example of a conventional mixing system that uses a lamella pump-type mixer. The mixer 16 includes a housing 9 with a first fluid inlet 11, a second inlet 13, and a fluid outlet 14. The mixer further includes a rotor 12 rotatably connected with the housing 9. The rotor 12 includes blades 15 positioned within housing 9 to define cells 17 between neighboring blades 15 and housing 9. Blades 15 may include one or more apertures 18 that extend through the blades in a straight or angled path. The apertures can be configured to let air or other fluid escape from inside cells 17 toward second inlet 13.

As can be seen in FIG. 2, a base composition 200 is advanced along a flow path 205 from a first fluid inlet 211 toward a fluid outlet 214. Particles 210 are communicated to the mixer through a second inlet 213, and then directed toward flow path 205 by rotating a rotor 212. Air can also enter the system as rotor 212 incorporates the particles 210. The air is removed from the process by directing air associated with the particles 210 from inside the cells 217 toward second inlet 213 via apertures in rotor blades 215, and/or forcing the air through gaps between rotor blades 215 and the mixer housing. Aperture sizes in the rotor blades 215 can range from about 0.1 mm to about 10 mm. Some non-limiting examples of apertured rotor blades suitable for use herein are described in U.S. Pat. No. 11,896,689. As illustrated in FIG. 2, particles 210 are combined with the base composition 200 to form a mixed composition (for example, a personal care composition such as a shampoo) and advanced from outlet 214.

When making mixed compositions such as those described above in connection with FIGS. 1 and 2, a region of low or no flow (“dead zone”) can exist near the pump outlet, which can result in an undesirable accumulation of particles or other compositional material associated with the first and/or second compositions. The inventors have surprisingly discovered that utilizing an obstruction proximate the pump outlet to disrupt the flow of the mixed composition can help mitigate dead zones and material accumulation.

### Mixing Systems

Improved mixing systems for making mixed compositions are provided herein. The mixed compositions can have a variety of different configurations, including, but not limited to liquid compositions containing intermixed particles and phased compositions including liquid-liquid compositions and liquid-slurry compositions.

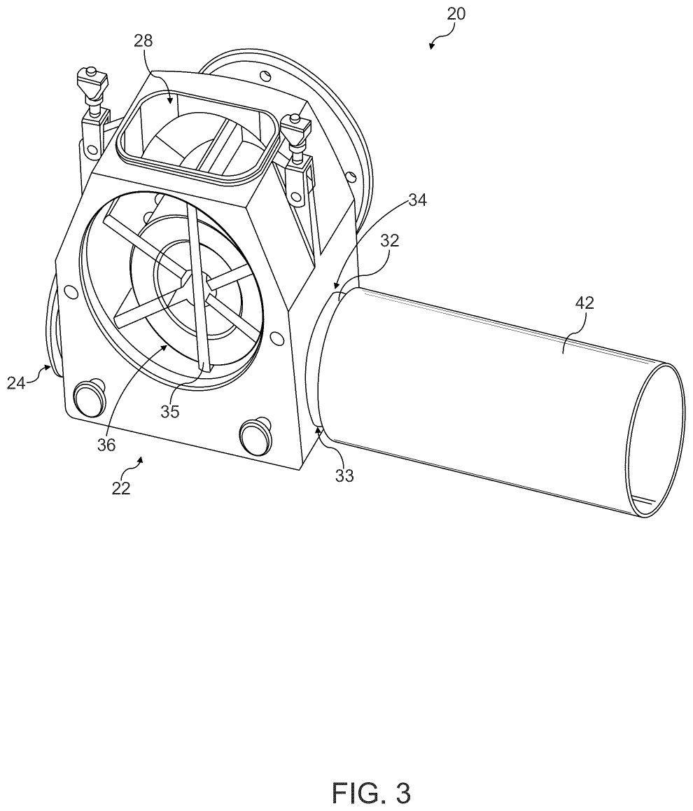

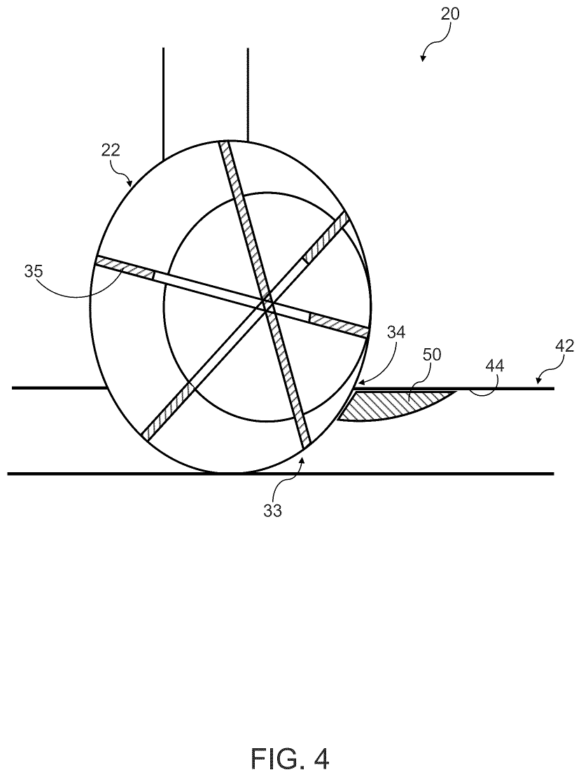

An exemplary mixing system 20 is shown in FIGS. 3 and 4, which includes a mixer 22 in the form of a lamella pump. Mixer 22 has a first inlet 24 for receiving a first composition, a second inlet 28 for receiving a second composition, and an outlet 32. Outlet 32 has a first side 33 and a second side 34. Lamella pumps contain rotatable blades 35 with cells 36 defined therebetween for carrying portions of the second composition from second inlet 28 and delivering it to the first composition to create a mixed composition. A downstream pipe 42 is disposed at outlet 32, which may be permanently or removably joined thereto by conventional means (for example, weld, compression fit, clamp, or adhesive), to receive the advancing mixed composition for further processing and/or packaging.

As illustrated in FIG. 4, a fluid flow obstruction 50 extends radially inwardly from an inner wall 44 of downstream pipe 42. Obstruction 50 is located at an upper wall portion (proximate the second outlet side 34) but it can be located at and extend radially inwardly from other inner wall portions of downstream pipe 42. The fluid flow obstruction 50 can be a separately manufactured component in the form of an insert and subsequently attached to the pump outlet and/or the downstream pipe 42. It can alternatively be manufactured integrally with the downstream pipe 42. Note that while the figures and description describe utilization of a single flow obstruction, multiple obstructions (similar or dissimilar) can be employed.

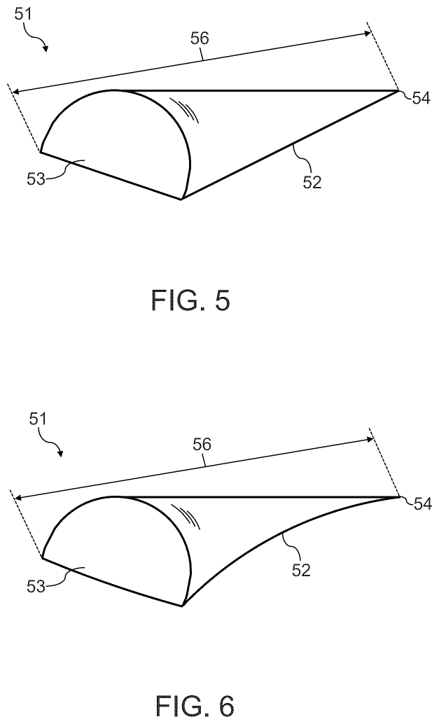

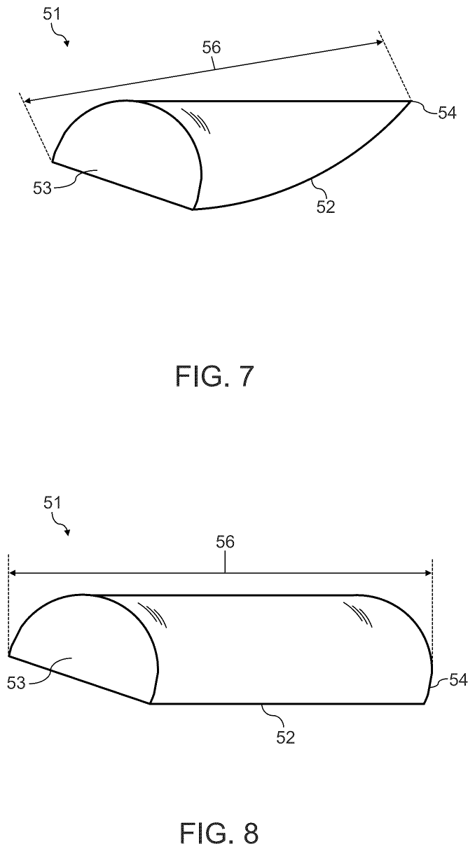

The fluid flow obstruction can have a variety of different geometries, be substantially solid or shell-like, and be made from various materials. As shown in FIG. 5, the fluid flow obstruction is in the form of an insert 51 that has an obstruction surface 52 and tapers from a first end 53 to an opposing second end 54. While the insert shown in FIG. 5 has a flat obstruction surface 52, it is to be appreciated that the obstruction surface 52 can be any suitable shape such as concave or convex, as shown in FIGS. 6 and 7, respectively. While illustrated with a tapered outer surface in FIGS. 5-7, the obstruction insert 51 can have a non-tapered outer surface, as shown in FIG. 8, wherein the cross-section of the obstruction is substantially uniform along its entire length.

The fluid flow obstruction can have varying dimensions. By way of example, the fluid flow obstruction can have a length 56 that is at least 0.1 times an inner diameter of the downstream pipe, including from about 0.5 to about 5, or from about 0.5 to about 3, times the inner diameter of the downstream pipe.

The flow obstruction can be located close to the lamella pump so there is minimal distance between the pump blades and the obstruction. Exemplary distances include less than 10 millimeters, less than 1 millimeter, or less than 0.1 millimeter (or as close as possible without contact with the rotating blades during manufacturing). The flow obstruction can also be located away from the pump outlet as much as it can and still provide the benefit described herein. Such distances can be, for example, less than 1 times, less than 0.5 times, or less than 0.25 times, an inner diameter of the downstream pipe.

Surface modifications can exist on the fluid flow obstruction, including, for example, dimples, depressions, and channels. Apertures and through-channels can also be incorporated into the fluid flow obstruction wherein some of the mixed composition can flow through the obstruction, whether the obstruction be solid or have a hollow portion (for example, having a shell-like configuration).

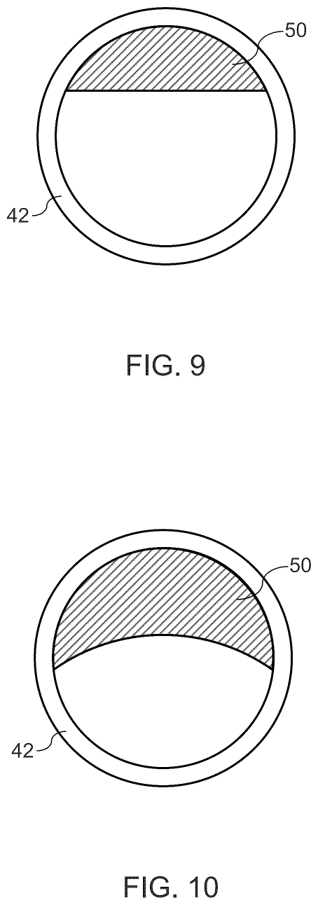

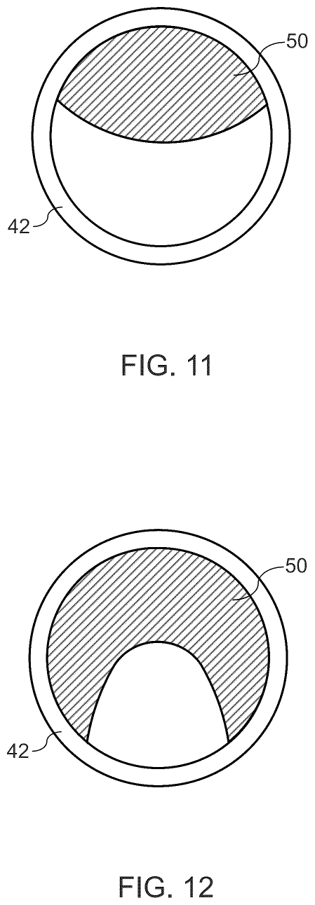

FIGS. 9-12 show exemplary obstruction 50 designs having different sizes and shapes. The cross-sectional geometry shown in these figures can occur at the first end of the obstruction, the second end of the obstruction, and/or anywhere along its length. The fluid flow obstruction can block from about 5% to about 50%, from about 10% to about 40%, or from about 15% to about 30%, of the inner cross-sectional area of pipe 42. Other flow blockage percentages of less than 100% are also contemplated herein.

### Methods of Making a Mixed Composition

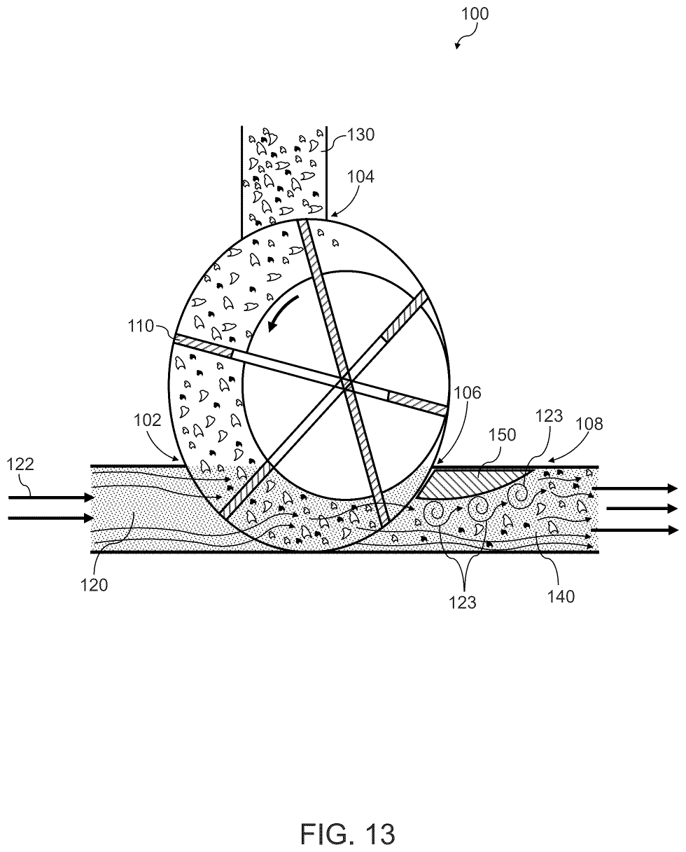

Methods of making mixed compositions are also provided. Note that while the mixing systems shown and described herein are useful for conducting the below-described methods, the methods are not limited to the same. In one example as illustrated in FIG. 13, the method utilizes a mixer 100 having a first inlet 102, second inlet 104, an outlet 106, and a downstream pipe 108. An exemplary fluid flow obstruction 150 is disposed within downstream pipe 108 proximate outlet 106. A first composition 120 is advanced along flow path 122. The first composition can be a base composition such as a personal care composition described in more detail below. Exemplary flow rates of the first composition include from about 1.5 L/min to about 250 L/min. A second composition 130 is communicated into mixer 100 via second inlet 104. The second composition may be particles or a particulate composition (for example, particles dispersed in a carrier), for example, as described below. Mixer blades 110 rotate within the mixer to combine second composition 130 with first composition 120 to create a mixed composition 140. As mixed composition 140 exits outlet 106, it encounters fluid flow obstruction 150 and is diverted around it. This flow diversion can cause deviations in the fluid flow properties of the mixed compositions, including, for example, creation of an eddy or vortex 123 (or other turbulent flow characteristics) that can help prevent, minimize, or better manage accumulation of particulate matter associated with at least one of the first and second compositions.

### Mixed Compositions

Mixed compositions made using the mixing systems and methods herein can include a base composition and particles dispersed within the base composition. The mixed composition can be packaged into a finished product (for example, shampoo, conditioner, or body wash) or added to one or more additional compositions prior and then packaged into a finished product. The base compositions can be formulated in a wide variety of product forms, including, but not limited to, liquids, creams, gels, emulsions, mousses, and sprays. For example, the mixed composition may be in the form of a pourable liquid under ambient conditions, and can have a viscosity of about 1 mPa-s to about 20 Pa-s (for example, about 100 mPa-s to about 15, Pa-s, 2 about, 500 mPa-s to about 12 Pa-s, about 3,500 mPa-s to about 8,500 mPa-s) measured at 26.6° C. with a Brookfield R/S Plus Rheometer, or equivalent, at 2 s⁻¹. Mixed compositions herein may be suitable for use as a personal care product (for example, shampoo, conditioner, face or body wash, face cream or body lotion), a laundry composition, a dish washing composition, a hard surface cleaner, or an oral care composition (for example, toothpaste or mouthwash). The mixed composition may be a rinse-off product or leave-on product.

### Base Composition

The base composition includes a surfactant system, a liquid carrier and, optionally, additional ingredients selected to tailor the properties and characteristics of the base composition and/or mixed composition.

The surfactant system may include a detersive surfactant to provide a cleaning benefit to soiled articles such as hair, skin, and hair follicles by facilitating the removal of oil and other soils. Detersive surfactants generally facilitate such cleaning due to their amphiphilic nature which allows for the surfactants to break up, and form micelles around, oil and other soils which can then be rinsed off, thereby removing them from the soiled article. The detersive surfactant can be an anionic surfactant, an amphoteric surfactant, a zwitterionic surfactant, a cationic surfactant, a nonionic surfactant or a mixture of these. Anionic surfactants may be particularly suitable for use as detersive surfactant in the surfactant system due to their desirable lather and cleaning properties. In some aspects, the surfactant system can be substantially free of sulfate-based surfactants, which may be perceived by some consumers as being harsh on skin and hair.

The surfactant system may include a co-surfactant to enhance the performance of the detersive surfactant. For example, the co-surfactant may enhance lather texture, volume and/or speed, improve composition stability, facilitate easier rinsing, and/or mitigate harshness. The co-surfactant can be selected from amphoteric, zwitterionic, cationic, and nonionic surfactants. The co-surfactant may be present in the base composition and/or mixed composition at about 0.5% to about 10%, (for example, about 0.75% to about 5%, about 1% to about 3%, or even about 1.25% to about 2%). In some aspects, the co-surfactant may be present in the base composition and/or mixed composition at a weight ratio of co-surfactant to detersive surfactant of 1:20 to 1:4 (for example, 1:12 to 1:7).

Some non-limiting examples of detersive surfactants and co-surfactants that may be suitable for use herein are described in U.S. Pat. No. 11,896,689.

Inclusion of an appropriate quantity of a liquid carrier can facilitate the formation of a base composition and/or mixed composition having appropriate viscosity and rheology. The viscosity of the composition can range from about 1 mPa-s to about 1,000 Pa-s. The liquid carrier may be present at about 20% to about 95%, or from about 60% to about 85%, by weight of the base composition and/or mixed composition. The level and species of the liquid carrier are selected according to the compatibility with other components and/or the desired characteristics of the base composition and/or mixed composition. In some aspects, the liquid carrier may be water or water solutions of lower alkyl alcohols. Suitable lower alkyl alcohols are monohydric alcohols having 1 to 6 carbons; for example, ethanol and isopropanol. A particularly suitable liquid carrier can be an aqueous carrier that is 30-100% water (deionized preferred), based on the weight of the liquid carrier. Water from natural sources including mineral cations can also be used, depending on the desired characteristics of the compositions.

The base composition may, optionally, include additional ingredients to tailor the properties and characteristics of the composition, as long as the additional ingredients are physically and chemically compatible with the above-described ingredients of the base composition or mixed composition. For example, optional ingredients should not unduly impair product stability, aesthetics, or performance. Some non-limiting examples of optional ingredients include structurants, rheology modifiers, high melting point fatty compounds, cationic polymers, conditioning agents, emulsifiers, chelating agents, deposition aids, anti-dandruff agents, suspending agents, dyes, nonvolatile solvents or diluents (water soluble and insoluble), pearlescent aids, foam boosters, pediculocides, pH adjusting agents, perfumes, preservatives, proteins, skin active agents, sunscreens, UV absorbers, and vitamins The CTFA Cosmetic Ingredient Handbook, Tenth Edition (published by the Cosmetic, Toiletry, and Fragrance Association, Inc., Washington, D.C.) (2004), describes a wide variety of non-limiting materials that can be added to the composition herein. Individual concentrations of optional ingredients can generally range from about 0.001% to about 10%, by weight of the base composition.

The base composition may include a structurant, such as, for example, a structurant described in U.S. Pat. No. 5,952,286. The structurant may have a melting point below about 25° C., and can include unsaturated and/or branched long chain (C8-C24) liquid fatty acids or ester derivative thereof; unsaturated and/or branched long chain liquid alcohol or ether derivatives thereof, and mixtures thereof. The surfactant also may comprise short chain saturated fatty acids such as capric acid and caprylic acid. Without being limited by theory, it is believed that the unsaturated part of the fatty acid of alcohol or the branched part of the fatty acid or alcohol acts to “disorder” the surfactant hydrophobic chains and induce formation of a lamellar phase.

The base composition may include a rheology modifier such as, for example, a cellulosic rheology modifier, a cross-linked acrylate, a cross-linked maleic anhydride co-methylvinylether, hydrophobically modified associative polymers, or a mixture thereof. In some aspects, an electrolyte can be added to the composition or formed in situ via the counterions present in one or more of the other ingredients. The electrolyte may include an anion comprising phosphate, chloride, sulfate or citrate and a cation comprising sodium, ammonium, potassium, magnesium or mixtures thereof. The electrolyte may be sodium chloride, ammonium chloride, sodium or ammonium sulfate. The electrolyte may be present in the base and/or mixed composition at about 0.1 wt % to about 15 wt % (for example, about 1 wt % to about 6 wt % or about 3 wt % to about 5 wt %).

The base composition may include a cationic polymer to allow formation of a coacervate during use of the mixed composition. As can be appreciated, the cationic charge of a cationic polymer can interact with an anionic charge of a surfactant to form the coacervate. Suitable cationic polymers can include: (a) a cationic guar polymer, (b) a cationic non-guar galactomannan polymer, (c) a cationic starch polymer, (d) a cationic copolymer of acrylamide monomers and cationic monomers, (e) a synthetic, non-crosslinked, cationic polymer, which may or may not form lyotropic liquid crystals upon combination with the detersive surfactant during use, (f) cationic synthetic homopolymers, (g) a cationic cellulose polymer, and (h) combinations thereof. Guar hydroxypropyltrimonium chloride, polyquaterium 10, polyquaternium 6, and combinations thereof may be particularly suitable.

The cationic polymer, when present, can be included at an amount of about 0.05 wt % to about 3 wt % (for example, about 0.075 wt % to about 2.0 wt % or about 0.1 wt % to about 1 wt %). The cationic polymer can have a cationic charge density of about 0.9 meq/g to about 7 meq/g (for example, about 1.2 meq/g to about 5 meq/g or about 1.5 meq/g to about 4 meq/g). Charge densities is determined at the pH of intended use of the composition (for example, between pH 3 and pH 9 or pH 4 and pH 8). The weight average molecular of the cationic polymer can be between about 10,000 Da and about 10 million Da (for example, about 50,000 Da to about 5 million Da, about 100,000 Da to about 3 million Da, about 300,000 to about 2 million Da and about 400,000 Da to about 1.5 million Da). In some aspects, lower molecular weight cationic polymers (for example, less than 2.5 million Da) may be used when greater translucency in the composition is desired. Some non-limiting examples of cationic polymers that may be suitable for use herein are disclosed in U.S. Pat. No. 11,896,689.

The base composition can include a conditioning agent to provide a conditioning benefit to hair, such as friction reduction, case of spreading, and/or case of detangling. The conditioning agent may be selected from silicones, hydrocarbon oils, polyolefins, fatty esters, fluorinated conditioning compounds, fatty alcohols, alkyl glucosides and alkyl glucoside derivatives, quaternary ammonium compounds, polyethylene glycols and polypropylene glycols having a molecular weight of up to 2,000,000 (for example, PEG-200, PEG-400, PEG-600, PEG-1000, PEG-2M, PEG-7M, PEG-14M, PEG-45M), and mixtures of these.

In some aspects, the conditioning agent can be a high melting point fatty compound, which can provide improved conditioning benefits compared to compositions containing no high melting point fatty compounds and/or compositions containing low melting point fatty compounds. The high melting point fatty may also provide improved stability of the composition by reducing the risk of phase separation. High melting point fatty compounds useful herein have a melting point of 25° C. or higher (for example, 40° C., 45° C., even 50° C. or higher, up to about 65° C.), but typically less than 90° C. (for example, less than 80° C. or 70° C.) in view of easier manufacturing and easier emulsification. The high melting point fatty compound can be used as a single compound or as a blend or mixture of at least two high melting point fatty compounds. When used as such blend or mixture, the above-described melting points are those of the blend or mixture. High melting point fatty compound useful herein are selected from the group consisting of fatty alcohols, fatty acids, fatty alcohol derivatives, fatty acid derivatives, and mixtures thereof.

Examples of suitable silicone conditioning agents, and optional suspending agents for the silicone, are described in U.S. Pat. Nos. RE34,584; 5,104,646; and 5,106,609. Suitable silicone conditioning agents can have a kinematic viscosity at 25° C. of about 20 centistokes (“csk”) to about 2,000,000 csk (for example, about 1,000 csk to about 1,800,000 csk, about 50,000 csk to about 1,500,000 csk, and about 100,000 csk to about 1,500,000 csk).

A base composition may include a fatty alcohol gel network to enhance hair conditioning and/or deposition of actives onto hair or to help stabilize the base composition and/or mixed composition. A gel network can be formed by combining fatty alcohols and surfactants at a ratio of 1:1 to 40:1 (for example, 2:1 to 20:1 or 3:1 to 10:1). The formation of a gel network involves heating a dispersion of the fatty alcohol in water with the surfactant to a temperature above the melting point of the fatty alcohol. During the mixing process, the fatty alcohol melts, allowing the surfactant to partition into the fatty alcohol droplets. The surfactant brings water along with it into the fatty alcohol. This changes the isotropic fatty alcohol drops into liquid crystalline phase drops. When the mixture is cooled below the chain melt temperature, the liquid crystal phase is converted into a solid crystalline gel network. The fatty alcohol can be included in the gel network at about 0.05% to about 14% (for example, about 1% to about 10% or about 6% to about 8%).

Fatty alcohols that may be suitable for use in the gel networks herein include those having 10 to 40 carbon atoms (for example, 12 to 22 carbon atoms, 16 to 22 carbon atoms, and 16 to 18 carbon atoms). The fatty alcohol can have a straight or branched chain and can be saturated or unsaturated. Some non-limiting examples of fatty alcohols that may be suitable for use herein include cetyl alcohol, stearyl alcohol, behenyl alcohol, and mixtures thereof. Mixtures of cetyl and stearyl alcohol in a ratio of from about 20:80 to about 80:20 may be particularly suitable.

The gel network can be prepared as a premix and mixed with the other ingredients of the base composition to form a dispersed phase in the composition. Examples of gel network premixes can be found in U.S. Pat. No. 8,361,448.

### Particles

The mixed compositions herein contain particles. Prior to mixing with the base composition, the particles are generally anhydrous and may be in the form of a dry, free-flowing powder. The particles may be suspended or dispersed in a carrier before being mixed with the base composition. The particles may be prepared by co-melting one or more fatty amphiphiles and one or more secondary surfactants and then cooled to solidify. Various methodologies can be used to control the particle size of such anhydrous particles. The particles may be added into an aqueous carrier and/or a base composition, which causes the particles to swell. The swollen particles remain discrete particles in the mixed composition, but generally have a larger particle size than their anhydrous counterpart.

The size of the particles herein can range from 200 μm to 15,000 μm (for example, 400 μm to 7,000 μm, 500 μm to 5,000 μm or even 750 μm to 3,000 μm). The size of the discrete particles in the mixed composition ranges from 200 μm to 20,000 μm (for example, 500 μm to 15,000 μm, 750 μm to 10,000 μm, 1,000 μm to 7,000 μm or even 2,000 μm to 5,000 μm). Particle size can be measured by conventional techniques (visually via ruler, light microscopy, etc.).

The particles herein can include a fatty amphiphile, which refers to a compound with a hydrophobic tail group and a hydrophilic head group. The fatty amphiphile is not water soluble and has a net neutral charge at the pH of the mixed composition. The fatty amphiphile may have a Hydrophilic-Lipophilic Balance (“HLB”) of 6 or less, according to Griffin, J. Soc. Cosm. Chem., vol. 5, 249 (1954).

Suitable fatty amphiphiles, or suitable mixtures of two or more fatty amphiphiles, have a melting point of at least about 27° C. The melting point, as used herein, may be measured by a standard melting point method as described in United States Pharmacopeia, USP-NF General Chapter <741>“Melting range or temperature”. The melting point of a mixture of two or more materials is determined by mixing the two or more materials at a temperature above the respective melt points and then allowing the mixture to cool. If the resulting composite is a homogeneous solid below 27° C., then the mixture has a suitable melting point. A mixture of two or more fatty amphiphiles, wherein the mixture comprises at least one fatty amphiphile having an individual melting point of less than 27° C., still is suitable for use provided that the composite melting point of the mixture is at least about 27° C.

Suitable fatty amphiphiles have a hydrophobic tail group. This hydrophobic tail group may be an alkyl, alkenyl (containing up to 3 double bonds), alkyl aromatic, or branched alkyl group with a length of 12 to 70 carbon atoms (for example, 16 to 60 carbon atoms. 16 to 50 carbon atoms, 16 to 40 carbon atoms, 16 to 22 carbon atoms, or even 18 to 22 carbon atoms). Non-limiting examples of alkyl, alkenyl, or branched alkyl groups suitable for the fatty amphiphiles include lauryl, tridecyl, myristyl, pentadecyl, cetyl, heptadecyl, stearyl, arachidyl, behenyl, undecylenyl, palmitoleyl, oleyl, palmoleyl, linoleyl, linolenyl, arahchidonyl, elaidyl, elaeostearyl, erucyl, isolauryl, isotridecyl, isomyristal, isopentadecyl, petroselinyl, isocetyl, isoheptadecyl, isostearyl, isoarachidyl, isobehnyl, gadoleyl, brassidyl, and technical-grade mixture thereof.

Suitable fatty amphiphiles also have a hydrophilic head group which does not make the compound water soluble, such as in compounds having an HLB of 6 or less. Non-limiting examples of classes of compounds having such a hydrophilic head group include fatty alcohols, alkoxylated fatty alcohols, fatty phenols, alkoxylated fatty phenols, fatty amides, alkyoxylated fatty amides, fatty amines, fatty alkylamidoalkylamines, fatty alkyoxyalted amines, fatty carbamates, fatty amine oxides, fatty acids, alkoxylated fatty acids, fatty diesters, fatty sorbitan esters, fatty sugar esters, methyl glucoside esters, fatty glycol esters, mono, di & tri glycerides, polyglycerine fatty esters, alkyl glyceryl ethers, propylene glycol fatty acid esters, cholesterol, ceramides, fatty silicone waxes, fatty glucose amides, fatty phosphate esters, and phospholipids. For additional discussion of fatty amphiphiles which are suitable for use, see United States Patent Application Number 2006/0024256 A1.

The particles can include one or more secondary surfactants, which is combined with the fatty amphiphile, co-melted and mixed, and then cooled to produce the particles. The secondary surfactant that is used for the preparation of the particles is separate from and in addition to the detersive surfactant and/or optional co-surfactant component of the base composition. However, the secondary surfactant may be the same or different type of surfactant as that or those selected for the detersive surfactant and/or optional co-surfactant component described above.

The particles herein may be anhydrous. Anhydrous particles contain less than 30% water or water miscible solvent (e.g., 0% to 30%, 0.5% to 25%, 1% to 15%, 2% to 10 or even 3% to 7%), by weight of the particle. The particles may include one or more additional ingredients to provide a formulation or performance benefit to the particles and/or a product containing the particles. For example, the additional ingredient may help provide more flexibility in the product composition rheology, improved stability in the product composition, improved deposition of a benefit agent on hair or skin (e.g., hair or skin conditioning agent, moisturizing agent, anti-dandruff agent, vitamin, mineral, or enzyme), improved visual/aesthetic appearance of the particle and/or product containing the particle and/or a fragrance. An additional ingredient may be present in the particle at 0.01% to 50% (e.g., 0.05% to 40%, 0.1% to 35%, 0.5% to 30%, 1% to 25%, 3% to 20%, 5% to 15% or about 10%), based on the weight of the particle.

It may be desirable to formulate the particles to provide a predetermined amount of a particular ingredient to a mixed composition (e.g., 0.05% to 30%, 0.1% to 15%, 0.5% to 10%, or 1% to 7%, based on the weight of the mixed composition). It can be important to tailor the amount of benefit agent present in the particles so as not to deteriorate the benefit of the mixed composition, especially any cleansing or hair condition agents (e.g., surfactants or high melting point fatty compounds).

The additional ingredient may be a conditioning agent (e.g., silicone polymer, cationic polymer or non-ionic polymer), a coloring agent such as FD&C or D&C dyes, pigments, mica or titanium dioxide, or any other benefit agent commonly found in hair and skin care products. Some nonlimiting examples of polymeric conditioning agents are described in US. A wide variety of other additional components can be formulated into the present compositions. These include: vitamins or pro-vitamins such as panthenol, panthenyl ethyl ether, hydrolysed keratin, proteins, plant extracts, and nutrients; preservatives such as benzyl alcohol, methyl paraben, propyl paraben and imidazolidinyl urea; pH adjusting agents, such as sodium hydroxide, sodium carbonate; perfume; ultraviolet and infrared screening and absorbing agents such as benzophenones;

sequestering agents, such as disodium ethylenediamine tetra-acetate; antidandruff agents such as zinc pyrithione and piroctone olamine; organic and inorganic salts such as sodium chloride.

The additional ingredient may be an ingredient that is incompatible with at least one other ingredient in the particle (incompatible agent) such as, for example, solid minerals or chemical substances that have high ionic strength and/or high surface charge and tend to cause agglomeration and/or crystallization. Some non-limiting examples of incompatible agents include acids, amino acids, mica, salicylic acid, and metal pyrithione (e.g., zinc pyrithione with or without ionic polymer coating or dispersion), and organic oil materials that are highly interactive with a gel network component (e.g., hexyldecanol and isostearyl isostearate). Other examples of incompatible ingredients include surfactants that interact with one another such as anionic and cationic surfactants.

Some non-limiting examples of particles that may be suitable for use with the mixing system herein are described in U.S. Pat. Nos. 11,931,441 and 11,628,126.

In some aspects, the particles may be in the form of a gellan film that includes about 30% to about 40% sodium alginate, about 40% to about 50% gellan gum, about 5% to about 10% polyvinyl alcohol, and about 5% to about 10% hydroxyl methyl cellulose sodium. The gellan film may optionally include one or more additional ingredients such as menthol, peppermint oil, menthyl lactate, jojoba oil, Vitamin E as well as dyes, other extracts and/or perfumes.

### EXAMPLES

TABLE 1
Base Composition Examples (hair care compositions)

| | A | B | C |
|---|---|---|---|
| Water | QS 100 | QS 100 | QS 100 |
| BTMS/IPA | 3 | | |
| Stearamidopropyl | | 3.57 | |
| Dimethylamine | | | |
| Sodium laureth sulfate | | | 15 |
| Sodium lauryl sulfate | | | 10 |
| Cocamidopropyl betaine | | | 5 |
| L-Glutamic Acid | | 0.34 | |
| Cetyl Alcohol | 1 | 1.2 | |
| Stearyl Alcohol | 2.5 | 3.0 | |
| Disodium EDTA | 0.13 | 0.13 | 0.13 |
| Benzyl Alcohol | 0.4 | 0.4 | 0.4 |
| Kathon CG | 0.03 | 0.03 | 0.03 |
| Guar | | | 0.2 |
| hydroxypropyltrimonium | | | |
| chloride | | | |
| Perfumes, silicones, | 1-10% | 1-10% | 1-10% |
| minors, salts etc. | | | |

### Combinations/Examples

1. A method of making a mixed composition, comprising:
   a) providing a mixer comprising a first inlet, a second inlet, an outlet, and a downstream pipe extending from the outlet;
   b) advancing a first composition in a flow path from the first inlet towards the downstream pipe;
   c) introducing a second composition into the first composition via the second inlet to create the mixed composition; and
   d) partially obstructing the flow of the mixed composition in a region of the downstream pipe that is proximate the outlet.
2. The method of paragraph 1, wherein the mixer comprises a lamella pump.
3. The method of paragraph 1 or 2, wherein the first composition is advanced at a flow rate of 1.5 L/min to 250 L/min.
4. The method of any one of the preceding paragraphs, wherein the first composition comprises a viscosity of 1 mPa-s to about 1,000 mPa-s.
5. The method of any one of the preceding paragraphs, wherein the first composition is a personal care base composition comprising a surfactant.
6. The method of any one of the preceding paragraphs, wherein the second composition comprises particles.
7. The method of paragraph 6, wherein the particles comprise a shape selected from spherical, hemispherical, prism, cone, cylinder, flake, ribbon, fiber, ellipsoidal, and combinations thereof.
8. The method of paragraph 6 or 7, wherein the particles comprise:
   a) a fatty compound selected from the group comprising fatty alcohols and fatty acids having a melting point of 25° C. or higher;
   b) a surfactant; and
   c) less than 30% water.
9. The method of any one of paragraphs 6 to 8, wherein the particles comprise a benefit agent selected from vitamins, soluble acids, perfumes, silicones, natural extracts, colorants, and combinations thereof.
10. The method of any preceding paragraph, wherein the mixed composition comprises 5 wt % to 35 wt % of a surfactant and 0.05 wt % to 10 wt % of particles.
11. The method of any one of the preceding paragraphs, wherein partially obstructing the flow of the mixed composition comprises including a fluid flow obstruction extending radially inwardly from an inner wall of the downstream pipe.
12. The method of paragraph 11, wherein the fluid flow obstruction blocks 5% to 50%, preferably 10% to 40%, and more preferably 15% to 30% of an inner cross-sectional area of the downstream pipe.
13. The method of paragraph 11 or 12, wherein the percentage of inner cross-sectional area blockage from the fluid flow obstruction decreases along a length of the fluid flow obstruction in a direction away from the outlet.
14. The method of any one of paragraphs 11 to 13, wherein the fluid flow obstruction comprises a surface that is flat, concave-shaped, or convex-shaped.
15. The method of any one of paragraphs 11 to 14, wherein the fluid flow obstruction comprises a length dimension that is at least 0.1 times an inner diameter dimension of the downstream pipe, preferably 0.5 to about 5 times the inner diameter dimension, and more preferably 0.5 to 3 times the inner diameter dimension.
16. The method of any one of paragraphs 11 to 15, wherein the fluid flow obstruction is an insert disposed within the downstream pipe proximate the outlet.
17. The method of any one of paragraphs 11 to 16, wherein the insert is capable of movement within the downstream pipe.
18. The method of any one of paragraphs 11 to 17, wherein the insert comprises surface modifications selected from dimples, depressions, apertures, channels, and combinations thereof.
19. A method of making a mixed fluid composition, comprising:
   a) providing a mixer comprising a first inlet, a second inlet, an outlet, and a downstream pipe extending from the outlet, wherein the mixer preferably comprises a lamella pump;
   b) advancing, preferably at a flow rate of 1.5 L/min to 250 L/min, a first fluid composition, preferably the base composition of paragraph 4 or 5, in a flow path from the first inlet towards the downstream pipe;
   c) introducing a second fluid composition via the second inlet to create the mixed fluid composition, wherein the second fluid composition comprises a plurality of particles, preferably the particles of any one of paragraph 7 to 9; and
   d) creating an eddy or vortex in a region of the downstream pipe that is proximate the outlet to help manage accumulation of particles in that region.
20. The method of paragraph 19, wherein the mixed composition comprises 5 wt % to 35 wt % of a surfactant and 0.05 wt % to 10 wt % of the particles.
21. The method of paragraph 19 or 20, wherein the eddy or vortex is created with the flow obstruction of any one of paragraphs 11 to 18.
22. A method of making a mixed composition, comprising:
   a) providing a mixer comprising a first inlet, a second inlet, an outlet, and a downstream pipe extending from the outlet, wherein the mixer preferably comprises a lamella pump;
   b) advancing, preferably at a flow rate of 1.5 L/min to 250 L/min, a fluid composition, preferably the base composition of paragraph 4 or 5, in a flow path from the first inlet towards the downstream pipe;
   c) introducing a plurality of particles, preferably the particles of any one of paragraphs 7 to 9, into the fluid composition via the second inlet to create the mixed fluid composition; and
   d) diverting flow of at least some of the mixed fluid composition in a region of the downstream pipe that is proximate the outlet to help manage accumulation of particles in that region.
23. The method of paragraph 22, wherein the mixed composition comprises 5 wt % to 35 wt % of a surfactant and 0.05 wt % to 10 wt % of the particles.
24. The method of paragraph 22 or 23, wherein the flow is diverted by the flow obstruction of any one of paragraphs 11 to 18.
25. A mixing system comprising:
   a) a lamella pump, comprising
      i) a first inlet for receiving a first composition,
      ii) a second inlet for receiving a second composition,
      iii) an outlet for communicating a mixed composition comprising the first and second compositions, and
      iv) spaced apart blades rotatable in a direction from a first side of the outlet to a second side of the outlet;
   b) a downstream pipe disposed at the outlet; and
   c) an obstruction disposed on an inner wall portion of the downstream pipe proximate the second side of the outlet, wherein the obstruction partially blocks flow of the mixed composition through the downstream pipe.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A method of making a mixed composition, comprising:
a) providing a mixer comprising a first inlet, a second inlet, an outlet, and a downstream pipe extending from the outlet;
b) advancing a first composition in a flow path from the first inlet towards the downstream pipe;
c) introducing a second composition into the first composition via the second inlet, wherein the mixed composition is created; and
d) partially obstructing the flow of the mixed composition in a region of the downstream pipe that is proximate the outlet.

2. The method of claim 1, wherein the mixer comprises a lamella pump.

3. The method of claim 1, wherein the step of advancing the first composition is conducted at flow rates of about 1.5 L/min to about 250 L/min.

4. The method of claim 1, wherein the first composition comprises a viscosity of about 1 mPa-s to about 1,000 mPa-s.

5. The method of claim 1, wherein the first composition is a personal care base composition comprising a surfactant.

6. The method claim 1, wherein the second composition comprises particles.

7. The method of claim 6, wherein the particles comprise a shape selected from spherical, hemispherical, prism, cone, cylinder, flake, ribbon, fiber, ellipsoidal, and combinations thereof.

8. The method of claim 6, wherein the particles have a longest dimension of about 400 microns to about 20,000 microns.

9. The method of claim 6, wherein the particles comprise:
a) a fatty compound selected from the group comprising fatty alcohols and fatty acids having a melting point of 25° C. or higher;
b) a surfactant; and
c) less than 30% water.

10. The method of claim 6, wherein the particles comprise a benefit agent selected from the group comprising vitamins, soluble acids, perfumes, silicones, natural extracts, colorants, and combinations thereof.

11. The method of claim 1, wherein the mixed composition comprises about 5 wt % to about 35 wt % of a surfactant and about 0.05 wt % to about 10 wt % of particles.

12. The method of claim 1, wherein the step of partially obstructing the flow of the mixed composition comprises including a fluid flow obstruction extending radially inwardly from an inner wall of the downstream pipe.

13. The method of claim 12, wherein the fluid flow obstruction blocks about 5% to about 50% of an inner cross-sectional area of the downstream pipe.

14. The method of claim 13, wherein the percentage of inner cross-sectional area blockage decreases along a length of the fluid flow obstruction in a direction away from the outlet.

15. The method of claim 12, wherein the fluid flow obstruction comprises a surface that is flat, concave-shaped, or convex-shaped.

16. The method of claim 12, wherein the fluid flow obstruction comprises a length dimension that is at least 0.1 times an inner diameter dimension of the downstream pipe.

17. The method of claim 12, wherein the fluid flow obstruction is an insert disposed within the downstream pipe proximate the outlet.

18. The method of claim 17, wherein the insert is capable of movement within the downstream pipe.

19. The method of claim 17, wherein the insert comprises surface modifications selected from the group comprising dimples, depressions, apertures, channels, and combinations thereof.

20. A method of making a mixed composition, the method comprising the steps of:
a) providing a mixer comprising a first inlet, a second inlet, an outlet, and a downstream pipe extending from the outlet;
b) advancing a fluid composition in a flow path from the first inlet towards the downstream pipe;
c) introducing a plurality of particles into the fluid composition via the second inlet, wherein the mixed fluid composition is created; and
d) creating an eddy or vortex in a region of the downstream pipe that is proximate the outlet to help manage accumulation of particles in that region.

21. A method of making a mixed composition, the method comprising the steps of:
a) providing a mixer comprising a first inlet, a second inlet, an outlet, and a downstream pipe extending from the outlet;
b) advancing a fluid composition in a flow path from the first inlet towards the downstream pipe;
c) introducing a plurality of particles into the fluid composition via the second inlet, wherein the mixed fluid composition is created; and
d) diverting flow of at least some of the mixed fluid composition in a region of the downstream pipe that is proximate the outlet to help manage accumulation of particles in that region.

22. A mixing system comprising:
a) a lamella pump, comprising
i) a first inlet for receiving a first composition,
ii) a second inlet for receiving a second composition,
iii) an outlet for communicating a mixed composition comprising the first and second compositions, and
iv) spaced apart blades rotatable in a direction from a first side of the outlet to a second side of the outlet;
b) a downstream pipe disposed at the outlet; and
c) an obstruction disposed on an inner wall portion of the downstream pipe proximate the second side of the outlet, wherein the obstruction partially blocks flow of the mixed composition through the downstream pipe.
